(19) United States
(12) Patent Application Publication
(10) Pub. No.: US 2018/0146170 A1
(43) Pub. Date: May 24, 2018

(54) OBJECT TRACKING METHOD

(71) Applicants: INVENTEC (PUDONG) TECHNOLOGY CORPORATION, Shanghai City (CN); INVENTEC CORPORATION, Taipei City (TW)

(72) Inventors: Chi-Chun YANG, Taipei City (TW); Ting-Yu HU, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 15/469,029

(22) Filed: Mar. 24, 2017

(30) Foreign Application Priority Data
Nov. 24, 2016 (CN) 201611056045.6

(51) Int. Cl. H04N 7/18; G08B 13/196; G06K 9/00

(52) U.S. Cl. CPC H04N 7/188; G06K 9/00785; H04N 7/181; G08B 13/19608

(57) ABSTRACT

An object tracking method, applied to an object tracking system, includes defining a number of monitoring points in a physical geographic region, wherein at least one camera set at each monitoring point, and is configured to capture a road image, selecting one monitoring point to be an initial monitoring point according to a position signal, related to the physical geographic region, defining at least one first priority point, wherein the first priority point is selected from the monitoring points, and has an adjacent relation to the initial monitoring point in the physical geographic region, determining whether the road image captured at the at least one first priority point comprises an object to be tracked, and when the road image comprises the object to be tracked, defining the first priority point, at which the object to be tracked is captured, as a next initial point.

### CROSS-REFERENCE TO RELATED APPLICATIONS

This non-provisional application claims priority under 35 U.S.C. § 119(a) on Patent Application No(s). 201611056045.6 filed in China on Nov. 24, 2016, the entire contents of which are hereby incorporated by reference.

### BACKGROUND

### Technical Field

This disclosure relates to an object tracking method, and more particularly to an object tracking method of predicting a moving direction of an object to execute image recognition on the road image captured at a monitoring point.

### Related Art

Along with the development of the Internet and the progress of image recognition, a great amount of monitors have been widely installed on the streets in many places to investigate traffic accidents or criminal cases. However, although the massive installment of monitors can enlarge the range of monitoring and avoid blind spots that cause the difficulties in grasping the process of traffic accidents and criminal cases accurately, the voluminous amounts of monitor data make it a far more time-consuming task to search certain images.

Generally speaking, when, for example, a burglary occurs on a street, the police have to check all the data in the monitors in around the crime scenes in order to sift the image data related to the case. This method is not merely inefficient. Omissions are considerably inevitable in telling whether the image data is related to the case. In addition, when it comes to a sudden occurrence of burglary, if the monitoring system is capable of assisting with sifting the image data instantly, it can effectively support the police in arresting the criminals and enhance the efficiency of solving a case.

### SUMMARY

This disclosure provides an object tracking method, applied to an object tracking system, includes: defining a number of monitoring points in a physical geographic region, wherein at least one camera set at each of the monitoring points, and the camera at each of the monitoring points is configured to capture a road image; selecting one of the monitoring points to be an initial monitoring point according to a position signal, related to the physical geographic region; defining at least one first priority point, wherein the first priority point is selected from the monitoring points, and the first priority point has an adjacent relation to the initial monitoring point in the physical geographic region; determining whether the road image captured at the at least one first priority point comprises an object to be tracked; and when the road image comprises the object to be tracked, defining the first priority point, at which the object to be tracked is captured, as a next initial point.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of an object tracking system in an embodiment of this disclosure;

FIG. 2 is a flow chart of an object tracking method in an embodiment of this disclosure;

FIG. 3 is a schematic diagram of a physical geographic region in an embodiment of this disclosure;

FIG. 4 is a schematic diagram of camera disposition at monitoring points in an embodiment of this disclosure;

FIG. 5 is a flow chart of an object tracking method in an embodiment of this disclosure;

FIG. 6 is a schematic diagram of a physical geographic region in an embodiment of this disclosure;

FIG. 7 is a schematic diagram of the physical geographic region in the embodiment as shown in FIG. 6; and

FIG. 8 is a schematic diagram of the physical geographic region in the embodiment as shown in FIG. 6.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

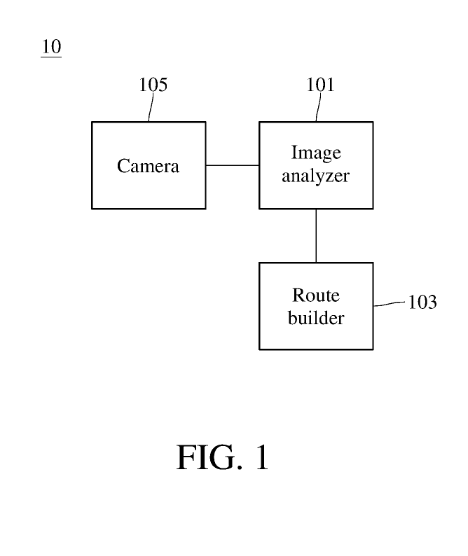

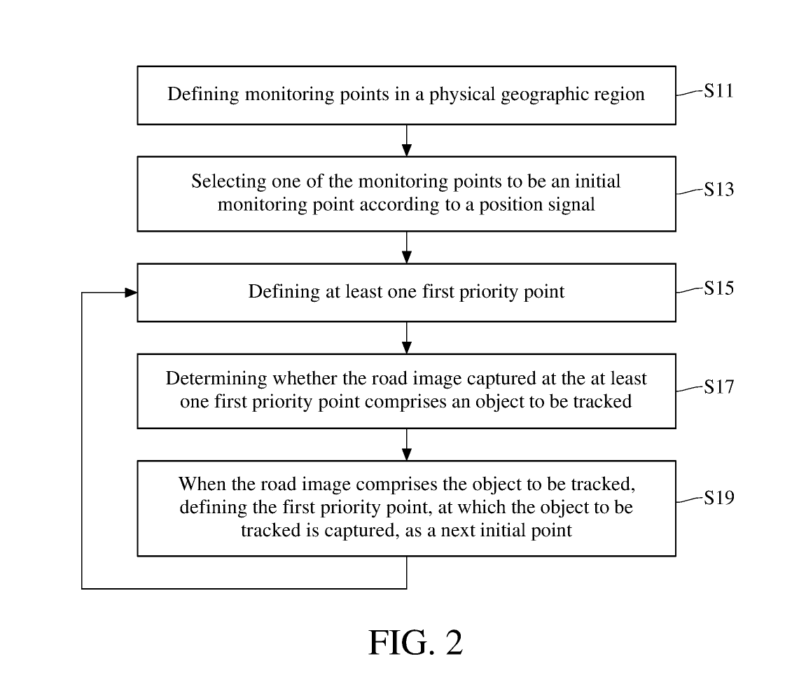

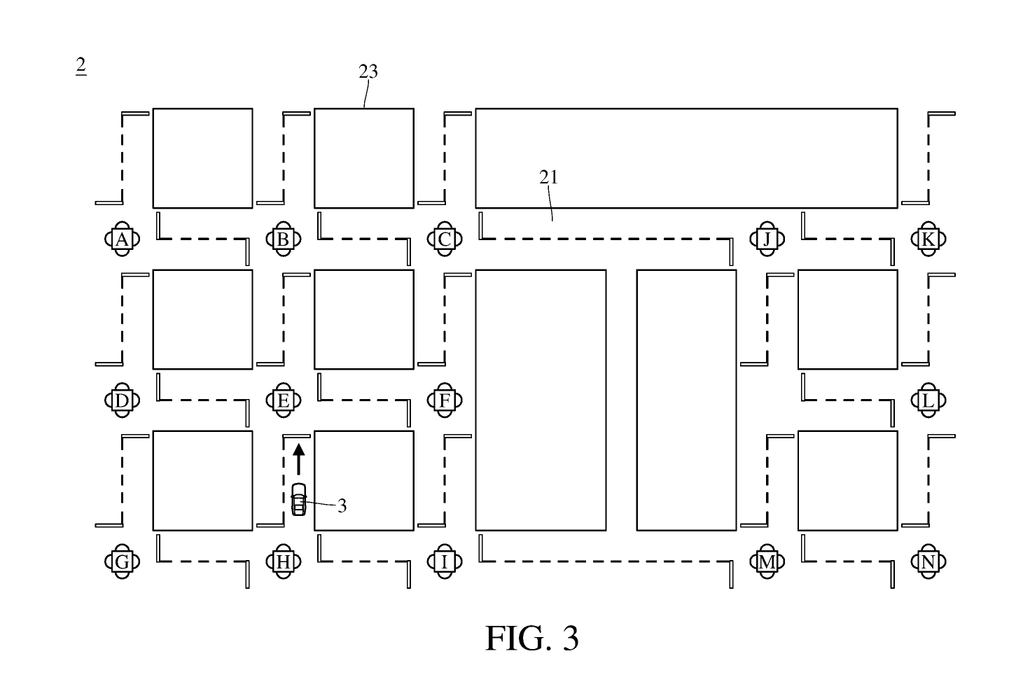

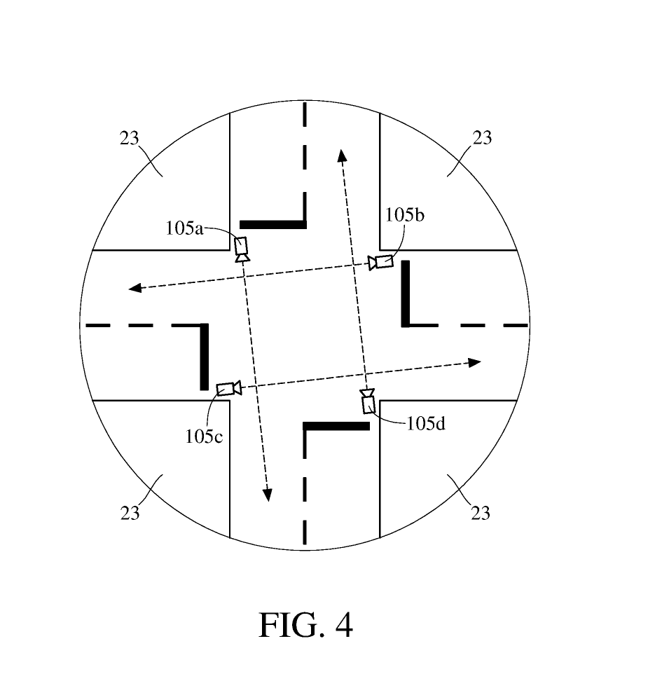

Please refer to FIG. 1 to FIG. 4. FIG. 1 is a functional block diagram of an object tracking system in an embodiment of this disclosure; FIG. 2 is a flow chart of an object tracking method in an embodiment of this disclosure; FIG. 3 is a schematic diagram of a physical geographic region in an embodiment of this disclosure; and FIG. 4 is a schematic diagram of camera disposition at monitoring points in an embodiment of this disclosure. As shown in the figures, an object tracking method is applied to an object tracking system 10 and includes an image analyzer 101, a route builder 103 and one or more cameras 105, but this disclosure is not limited to this implementation. Person having ordinary skill in the art is able to add other device such as a notifier into the object tracking system 10 based on a practical requirement and this disclosure does not intend to limit the device in the object tracking 10.

In step S11, the object tracking system 10 defines a number of monitoring points A-N in a physical geographic region 2. As shown in FIG. 3, the physical geographic region 2 includes a number of road sections 21. For example, one road section 21 is adjacent to one or more city blocks 23. Each of the monitoring points A-N is defined between at least two adjacent road sections 21 among the road sections 21. For example, each of the monitoring points A-N is defined at an intersection of the crossroads, or an intersection of the T-road. In this disclosure, defining the monitoring points A-N means setting the cameras 105 at the monitoring points A-N. One or more cameras 105 are set at each of the monitoring points A-N to capture one or more road images of one or more road sections 21.

As shown in FIG. 4, there are four cameras 105a-105d set at one of the monitoring points A-N. The cameras 105a-105d capture the road images respectively toward various directions, such as the driving direction or the direction opposite to the driving direction. This disclosure does not intend to limit the direction toward which the cameras 105a-105d capture the road images. When there are four cameras 105a-105d set at one monitoring point, each of the cameras 105a-105d capture the road image so that the monitoring point obtains four road images and transmits them to the image analyzer 101 for selectively executing image recognition or storing. For convenience of explanation, the following one or more embodiments are described in the situation of capturing the road image toward the driving direction, but this disclosure is not limited to them.

As shown in FIG. 3, any two of the monitoring points A-N are connected to each other via one or more road sections 21. For example, the monitoring point E and the monitoring point F are connected to each other via one road section 21, and the monitoring point J and the monitoring point L are connected to each other via two road sections 21. In other words, when two of the monitoring point A-N are connected to each other via many road sections 21. The road sections 21 between the two monitoring points are not limited to continue along a single direction. The road sections 21 between the two monitoring points may have included angles therebetween. Moreover, in this embodiment, two of the monitoring points A-N, which have an adjacent relation to each other, are connected to each other merely via the road section 21, and no other monitoring point is set between the two adjacent monitoring points. For example, the monitoring point E has the adjacent relation to the monitoring point F, but the monitoring point E does not have the adjacent relation to the monitoring point I because there is the monitoring point F between the monitoring point E and the monitoring point I. However, the definition of the road sections 21 is used for convenience of defining the monitoring points A-N, but in practice, the physical geographic region is not limited to this implementation.

In step S13, the route builder 103 of the object tracking system 10 selects one of the monitoring points A-N to be an initial monitoring point according to a position signal which relates to the physical geographic region 2. For example, the position signal is an address, such as an address where an event occurs, an address where an object 3 is detected or other address which is suitable for providing a position related to the object 3. The route builder 103 searches the road section 21 corresponding to the address (position signal) in the physical geographic region 2, and selects one of the monitoring points A-N to be the initial monitoring point. For example, in FIG. 3, the route builder 103 can select the monitoring point H or the monitoring point E to be the initial monitoring point according to the position of the object to be tracked 3. In an embodiment, the route builder 103 selects the monitoring point, which has a least distance from the position indicated by the positional signal, to be the initial monitoring point.

In step S15, according to the initial monitoring point, the route builder 103 defines at least one first priority point, which is selected from the monitoring points A-N, and the first priority point has an adjacent relation to the initial monitoring point in the physical geographic region 2. If the monitoring point H is defined as the initial monitoring point in the previous step, the monitoring points G, the monitoring points E and the monitoring points I respectively have adjacent relations to the monitoring point H. The route builder 103 defines the monitoring points G, the monitoring points E and the monitoring points I as the first priority points according to the monitoring points adjacent to the monitoring point H, after defining the monitoring point H as the initial monitoring point.

In step S17, the image analyzer 101 determines whether the road image captured at each of the first priority points includes the object to be tracked 3. In other words, the image analyzer 101 obtains the road images respectively captured at the monitoring points G, the monitoring points E and the monitoring points I, and recognizes the road images to determine whether the road images include the object to be tracked 3. For example, if the object to be tracked 3 is transportation, the image analyzer 101 recognizes the license plate number of the transportation in order to check whether the road images includes the license plate number of the object to be tracked 3, but this disclosure does not intend to limit the image analyzer 101, according to which feature of the object to be tracked 3, determines whether the road image captured at each of the first priority points includes the object to be tracked 3.

In step S19, when the one or more road images include the object to be tracked 3, the first priority point at which the object to be tracked 3 is captured is defined as the next initial monitoring point. For example, in FIG. 3, the image analyzer 101 recognizes that the road image captured at the monitoring point E includes the object to be tracked 3, so that the monitoring point E is defined as the next initial monitoring point. Then, the steps S15 to S19 are repeated; and it means the monitoring point B, the monitoring point D, the monitoring point F and the monitoring point H, which respectively have adjacent relations to the monitoring point E, are defined as the first priority points, and the image analyzer 101 determines whether the object to be tracked 3 is captured at the monitoring points which are defined as the first priority points.

The object tracking system 10 tracks an object by defining the initial monitoring point step by step, and predicts a moving direction of the object by defining one or more first priority points, so that the image analyzer 101 does not need to analyze road images captured by all cameras 105 in a region. The image analyzer 101 merely determines whether the object to be tracked 3 is captured at the monitoring point which is defined as the first priority point. Therefore, the amount of data to be processed by the object tracking system 10 is reduced so that the recognition rate and the efficiency of handling a case are enhanced.

In an embodiment, after the monitoring point, at which the object to be tracked 3 is captured, is defined as the initial monitoring point, the first priority point is defined further according to a capturing direction of the camera 105 which captures the object to be tracked 3, in step S15. In other words, explained by the aforementioned embodiment, when there are three cameras 105 set at the monitoring point H and the cameras 105 capture the road images respectively toward the monitoring point G, the monitoring point E and the monitoring point I, the cameras 105 of the monitoring point H are further arranged to capture images toward the driving direction of the object to be tracked 3. Therefore, after the monitoring point H is defined as the initial monitoring point, the moving direction of the object to be tracked 3, from the monitoring point H to the monitoring point E, can be obtained according to the camera 105, at the monitoring point H, which captures the object to be tracked 3. Therefore, the route builder 103 is able to define the monitoring point E as the first priority point according to the moving direction of the object to be tracked 3 so as to reduce the amount of image data which the image analyzer 101 processes.

Besides reducing the amount of image data processed by the image analyzer 101, the route builder 103 defines the first priority point by determining the moving direction of the object to be tracked 3 so that the route builder 103 is able to double check whether the object to be tracked 3 leaves the road section 21, between the monitoring point H and the monitoring point E, through another one of three road sections 21 connected to the monitoring point E. When the object to be tracked 3 does not leave the road section 21 between the monitoring point H and the monitoring point E through another one of three road sections 21 connected to the monitoring point E, the object to be tracked 3 stays the road section 21 between the monitoring point H and the monitoring point E. At the same time, the route builder 103 is further able to notify the police to patrol at the road section 21 between the monitoring point H and the monitoring point E via the added notifier. In an embodiment, the route builder 103 defines the initial monitoring point step by step to track the object so that a moving route of the object to be tracked 6 can be built. The moving route of the object to be tracked 6 can further be announced, by wireless transmission via the added notifier, to the network of the police for providing the moving route of the object to be tracked 6 to the police.

In an embodiment, when the camera 105 at the monitoring point, which is defined as the first priority point in step 15, does not capture the road image, the route builder 103 is further able to define a number of second priority points according to the first priority point at which the road image is not captured. For example, the damage to the camera 105 at the monitoring point, the files saved in the camera 105 or the transmission route, or other reason may cause that the camera 105 at the monitoring point does not capture the road image. The second priority points are similarly selected from the monitoring points A-N and have adjacent relations to the first priority point in the physical geographic region 2.

For example, in step S15, when the monitoring point E is defined as the first priority point but the camera 105 at the monitoring point E does not capture the road image, the monitoring point D, the monitoring point B and the monitoring point F, which have adjacent relations to the monitoring point E, are selected to be the second priority point. Afterwards, in step S17, besides determining whether the road image captured at each first priority point includes the object to be tracked 3, the image analyzer 101 also determines whether the road image captured at each second priority point includes the object to be tracked 3. When the camera 105 at the second priority point captures the object to be tracked 3, the second priority point is similarly defined as the next initial monitoring point, and then the prediction of the moving direction of the object to be tracked 3 is executed.

Similarly, when the camera 105 at the monitoring point which is defined as the second priority point does not capture the road image, the route builder 103 is further able to define a number of third priority points according to the second priority point at which the road image is not captured. The third priority points are similarly selected from the monitoring points A-N, and have adjacent relations to the above second priority point. Person has ordinary skill in the art is able to design the third priority points according to the practical requirement so the related details are not described again.

In an embodiment, the road image which includes the object to be tracked 3 and is captured at the first priority point is stored in data storage, so that the road image can be one piece of evidence after the mission of tracking the object to be tracked 3 is completed, and the moving route of the object to be tracked 3 can be analyzed. In other words, besides the image analyzer 101, the route builder 103 and one or more cameras 105, the object tracking system 10 further includes the data storage, such as the memory or other suitable device.

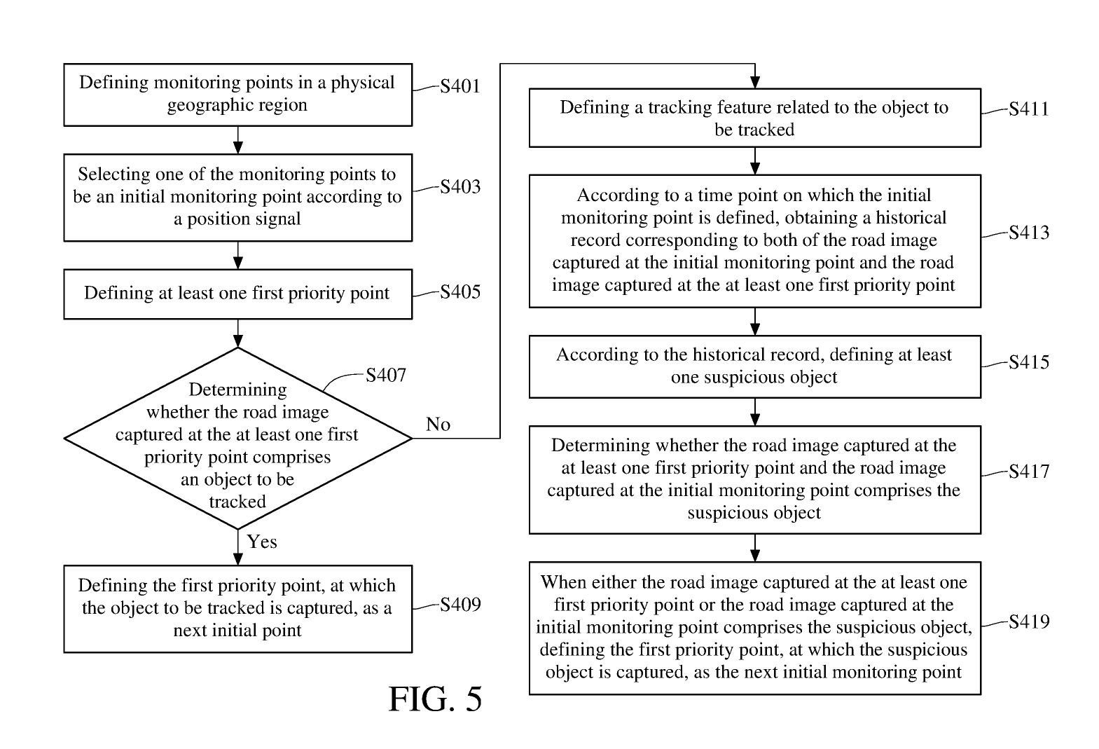

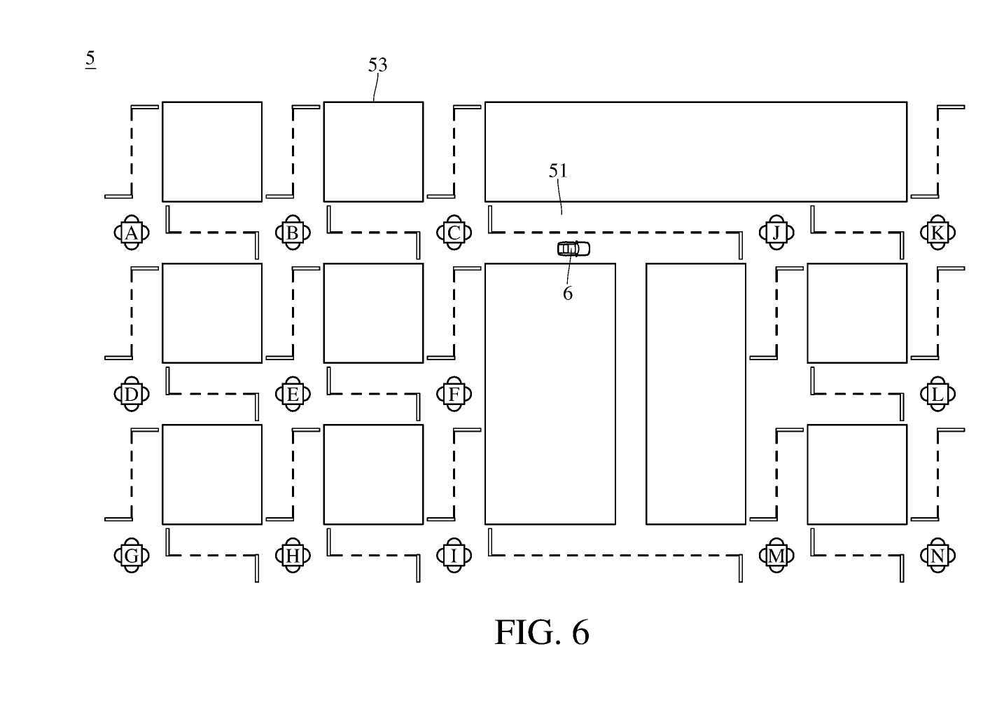

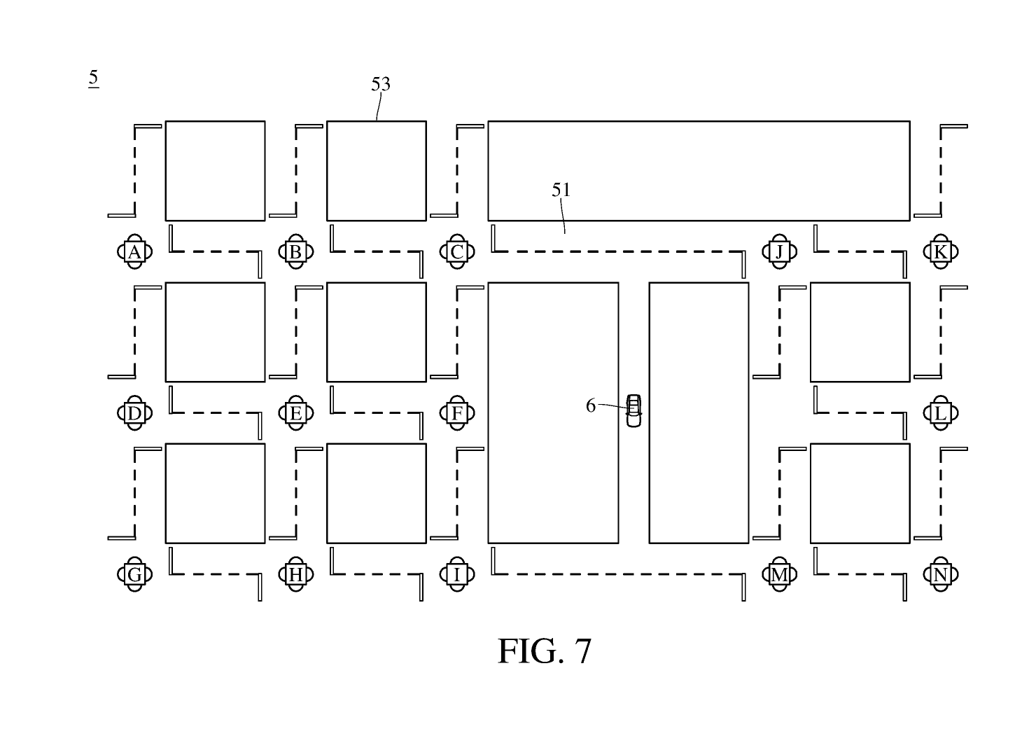

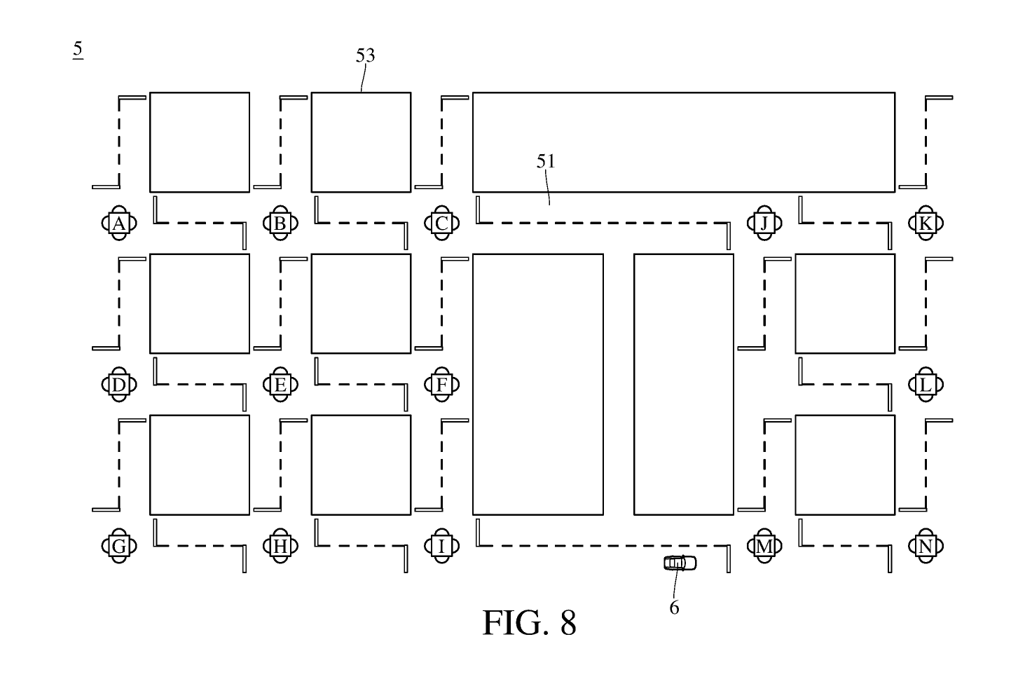

Please refer to FIG. 2 and FIG. 5 to FIG. 8. FIG. 5 is a flow chart of an object tracking method in an embodiment of this disclosure; FIG. 6 is a schematic diagram of a physical geographic region in an embodiment of this disclosure; FIG. 7 is a schematic diagram of the physical geographic region in the embodiment as shown in FIG. 6; and FIG. 8 is a schematic diagram of the physical geographic region in the embodiment as shown in Fig. As shown in the figures, in step S401, the object tracking system 10 defines a number of the monitoring points A-N in a physical geographic region 5. The physical geographic region 5 includes a number of road sections 51. For example, one road section 51 is adjacent to one or more city blocks 53. Each of the monitoring points A-N is defined between at least two adjacent road sections 51 among the road sections 51, and at least one camera 105 is set at each of the monitoring points A-N to capture the road image of the road section 51. Any two of the monitoring points A-N are connected to each other via one or more road sections 51, and two monitoring points which have an adjacent relation therebetween are connected to each other via the road section 51 without any monitoring point.

In step S403, the route builder 103 selects one monitoring point and defines it as the initial monitoring point according to a position signal which relates to the physical geographic region 5. In other words, the route builder 103 searches the road section 51 corresponding to the position signal in the physical geographic region 5, and selects one of the monitoring points A-N to be the initial monitoring point according to the corresponding road section 51. In step S405, according to the initial monitoring point, the route builder 103 defines at least one first priority point, which is selected from the monitoring points A-N, and the first priority point has an adjacent relation to the initial monitoring point in the physical geographic region 5. In this embodiment, after defining the monitoring point, at which the object to be tracked 6 is captured, as the initial monitoring point, in step S405, the route builder 103 defines the first priority point further according to the moving direction of the object to be tracked 6. In a practical example, as shown in FIG. 6, when the monitoring point C is the initial monitoring point and the object to be tracked 6 moves toward the monitoring point J and is captured at the monitoring point C, the monitoring point J, the monitoring point I and the monitoring point M are defined as the first priority points.

In step S407, the image analyzer 101 determines whether the road image captured at each of the first priority points includes the object to be tracked 6. For example, the image analyzer 101 determines whether any road image captured by the monitoring point J, the monitoring point I and the monitoring point M includes the object to be tracked 6 by recognizing whether the license plate number of the object to be tracked 6 is included in the road image captured at each of the first priority points. When the object to be tracked 6 is included in the road images, in step S409, the first priority point, at which the object to be tracked 6 is captured, is defined as the next initial monitoring point, and after step S409, steps S401 to S407 are repeated to continue predicting the moving direction of the object to be tracked 6.

When the object to be tracked 6 is not included in the road images, the object to be tracked 6 does not leave the region formed by the road sections 51 among the monitoring point C, the monitoring point J, the monitoring point M and the monitoring point I. As a practical example, the object to be tracked 6 may stay in the road section 51 among the monitoring point C, the monitoring point J, the monitoring point I and the monitoring point M, as shown in FIG. 7. At that time, the route builder 103 is further able to notify the police to patrol at the road sections 51 among the monitoring point C, the monitoring point J, the monitoring point I and the monitoring point M via the added notifier. In an embodiment, the route builder 103 is further able to build the moving route of the object to be tracked 6 and announce it to the online police, by the wireless transmission via the notifier, for providing the moving route of the object to be tracked 6 to the police. As another practical example, the object to be tracked 6 may change the license plate and leave the road sections 51 among the monitoring point C, the monitoring point J, the monitoring point I and the monitoring point M.

Therefore, in step S411, at least one tracking feature related to the object to be tracked 6 is defined. The tracking feature is, for example, the band, type, color, or other suitable tracking feature of the object to be tracked 6. In step S413, a historical record corresponding to both of the road image captured at the initial monitoring point and the road images captured at the first priority points according to a time point on which one of the monitoring points A-N is defined as the initial monitoring point. In other words, in this embodiment, the initial monitoring point is the monitoring point C so that the image analyzer 101 captures the historical record corresponding to the road images captured at the monitoring point C, the monitoring point J, the monitoring point I and the monitoring point M.

In step S415, a suspicious object is defined according to the captured historical record. More specifically, the image analyzer 101 searches the object to be tracked 6 from the historical record by determining which object has the tracking feature of the object to be tracked 6. Besides, the route builder 103 defines the object with the tracking feature as the suspicious object, and considers the suspicious object to be the object to be tracked 6. For example, the route builder 103 searches the suspicious object by its license plate number. In step S417, the image analyzer 101 determines whether the road image captured at the initial monitoring point and the road image captured at each first priority point includes the suspicious object. In step S419, when either the road image captured at the one of the first priority point or the road image captured at the initial monitoring point includes the suspicious object, the route builder 103 defines the first priority point, at which the suspicious object is captured, as the next initial monitoring point. For example, as shown in FIG. 8, the road image captured at the monitoring point M includes the suspicious object so that the monitoring point M is defined as the next initial monitoring point.

More concretely, the suspicious object is regarded as an object to be tracked which is same as the object to be tracked 6 but is tracked independently of the object to be tracked 6. For example, a first suspicious object and a second suspicious object are defined in step S415. When the first suspicious object is captured at the monitoring point C, the route builder 103 defines the monitoring point C as the initial monitoring point, and tracks the first suspicious object by one or more monitoring points which have adjacent relations to the monitoring point C. When the second suspicious object is captured at the monitoring point M, the route builder 103 defines the monitoring point M as the initial monitoring point and tracks the second suspicious object by one or more monitoring points which have adjacent relations to the monitoring point M, and the tracking details are not described again.

In view of the above statement, this disclosure provides an object tracking method. By setting the monitoring point, at which an object to be tracked is found, as an initial monitoring point, defining one or more first priority points according to the initial monitoring point, predicting a moving direction of the object to be tracked, and executing image recognition of one or more road images captured on the predicted moving direction of the object to be tracked, the amount of data which the object tracking system has to execute the image recognition is reduced, and the object tracking system does not need to execute the image recognition of all the road images in a region at a time, so that the efficiency of the image recognition is enhanced and the object tracking method may real-time support the police to track the object to be tracked to enhance the efficiency of solving a case.

What is claimed is:

1. An object tracking method, applied to an object tracking system, comprising steps of:
defining a plurality of monitoring points in a physical geographic region, wherein at least one camera set at each of the plurality of monitoring points, and the camera at each of the plurality of monitoring points is configured to capture a road image;
selecting one of the plurality of monitoring points to be an initial monitoring point according to a position signal related to the physical geographic region;
defining at least one first priority point, wherein the at least one first priority point is selected from the plurality of monitoring points, and the at least one first priority point has an adjacent relation to the initial monitoring point in the physical geographic region;
determining whether the road image captured at the at least one first priority point has an object to be tracked; and
when the road image comprises the object to be tracked, defining the first priority point, at which the object to be tracked is captured, as a next initial point.

2. The object tracking method according to claim 1, wherein when the camera at the at least one first priority point does not capture the road image, the object tracking method further comprises step of:
defining a plurality of second priority points, wherein each of the plurality of second priority points is selected from the plurality of monitoring points, and has the adjacent relation to the at least one first priority point, at which the road image is not captured, in the physical geographic region.

3. The object tracking method according to claim 2, further comprising steps of:
determining whether the road image captured at each of the plurality of second priority points comprises the object to be tracked; and
when the road image captured at the at least one first priority point does not comprise the object to be tracked and the road image captured at one of the plurality of second priority points comprises the object to be tracked, defining the second priority point as the next initial monitoring point.

4. The object tracking method according to claim 1, wherein after defining the monitoring point, at which the object to be tracked is captured, as the next initial monitoring point, the step of defining the at least one first priority point further comprises:
defining the at least one first priority point according to a moving direction of the object to be tracked in the road image.

5. The object tracking method according to claim 4, wherein when the road image captured at the at least one first priority point does not comprises the object to be tracked, the object tracking method further comprises:
defining at least one tracking feature related to the object to be tracked;
according to a time point on which one of the plurality of monitoring points is defined as the initial monitoring point, obtaining a historical record corresponding to both of the road image captured at the initial monitoring point and the road image captured at the at least one first priority point;
according to the historical record, defining at least one suspicious object which has the at least one tracking feature;
determining whether the road image captured at the at least one first priority point and the road image captured at the initial monitoring point comprises the suspicious object; and
when either the road image captured at the at least one first priority point or the road image captured at the initial monitoring point comprises the suspicious object, defining the first priority point, at which the suspicious object is captured, as the next initial monitoring point.

6. The object tracking method according to claim 1, wherein when an amount of the at least one camera, set at one of the plurality of monitoring points, is more than one, each of the cameras set at the monitoring point respectively captures the road image toward one of various capturing directions.

7. The object tracking method according to claim 1, wherein the physical geographic region has a plurality of road sections, each of the plurality of monitoring points is defined between at least two of the plurality of road sections, and each of the monitoring points, which has the adjacent relation to one another, is connected to one another via at least one of the plurality of road sections.

8. The object tracking method according to claim 1, further comprising:
storing the road image comprising the object to be tracked into data storage.
